(19) United States
(12) Patent Application Publication
(10) Pub. No.: US 2019/0030472 A1
(43) Pub. Date: Jan. 31, 2019

(54) FILTRATION DEVICE

(71) Applicant: MIRAIAL CO., LTD., Tokyo (JP)

(72) Inventors: Junpei Soma, Tokyo (JP); Tsuyoshi Nagashima, Tokyo (JP); Nobuyuki Kasama, Tokyo (JP)

(73) Assignee: MIRAIAL CO., LTD., Tokyo (JP)

(21) Appl. No.: 15/570,685

(22) PCT Filed: Apr. 30, 2015
(86) PCT No.: PCT/JP2015/063046

§ 371 Date: Feb. 21, 2018

(51) Int. Cl. B01D 35/30; B01D 29/11

(52) U.S. Cl. CPC B01D 35/30; B01D 29/114; B01D 2201/4053; B01D 2201/305; B01D 2201/4061; B01D 2201/302

(57) ABSTRACT

A filtration device (1) includes a filter housing (10) having at least one axial direction stopper for restricting displacement of a filter cartridge (20) in a housing axial direction, and at least one rotational direction stopper for restricting displacement of the filter cartridge (20) in a rotational direction around a housing axis, wherein the filter cartridge (20) is removably secured to a bowl (11) within the filter housing (10) by the at least one axial direction stopper and the at least one rotational direction stopper.

### TECHNICAL FIELD

The present invention relates to a filtration device comprising a filter housing and a replaceable filter cartridge housed in the filter housing, the filtration device being configured to filter liquid by passing it through a filter portion of the filter cartridge. More particularly, the present invention proposes a technique capable of replacing the filter cartridge and stably holding the filter cartridge in the filter housing even under certain restrictions on an arrangement space of the filter device.

### BACKGROUND ART

This type of filtration device generally comprises a filter housing having a head provided with an inflow port and an outflow port through which liquid flows in or flows out, as well as a cylindrical bowl with a bottom, removably connected to the head; and a filter cartridge housed in the filter housing, and the device being used, for example in a filtration process for filtering pure water, chemical liquid, or the like, employed during manufacturing of semiconductors, electronic parts, and other various materials.

In such a filtration process, the use of the filtration device for a certain period of time will lead to decreased collection performance of contaminants due to adhesion of the contaminants contained in wastewater to be filtered to particularly a filter portion of the filter cartridge. Therefore, it is necessary to replace the filter cartridge with a new one in order to obtain high-purity liquid or the like required for the filtration process when a certain period of service of the filtration device has elapsed.

If the filter cartridge of the filtering device has a structure in which the filter cartridge is suspended from a head side of the filter housing and is removably fixed, a bowl of the filter housing is first removed from the head disposed at a position where the above filtering process is performed, in order to replace the filter cartridge. The filter cartridge, suspended from and fixed to the head, is then removed. In this case, when removing the bowl from the head, it is necessary to move the bowl downward away from the head along the axial direction of the housing until the entire filter cartridge present inside the bowl are exposed. Therefore, for such a filtration device, it will be difficult to replace the filter cartridge if, in the arrangement space of the filter device, a space corresponding to the length of the filter cartridge in the axial direction of the housing, in addition to the length of the bowl in the axial direction of the housing, is not ensured on the lower side of the bowl.

With respect to this, Patent Document 1 discloses “a mass transfer or energy transfer cartridge which comprises: an elongated medium capable of effecting mass transfer therethrough or for effecting energy transfer from a first fluid to a second fluid, said elongated medium having a first end and a second end, a first sealing plate sealed to said first end, a second sealing plate having a fluid passageway having a fluid passage sealed to said second end, a fluid passageway sealed to said first sealing plate to provide fluid communication to an open interior within said medium, and said first sealing plate having at least two flanges which extend beyond an outer surface of said medium”, in order to “reduce the space required to install the mass transfer or energy transfer module” and the like. Similar techniques are also disclosed in Patent Documents 2 and 3, and the like.

### CITATION LIST

### Patent Literature

Patent Document 1: Japanese Patent Application Public Disclosure (KOHYO) No. 2008-505760 A1. Patent Document 2: Japanese Patent No. 4266833 B1. Patent Document 3: Japanese Patent No. 4664596 B1.

### SUMMARY OF INVENTION

### Technical Problem

The “mass transfer or energy transfer cartridge” described in Patent Document 1 causes a problem that when performing the filtration, unintended displacement of the filter cartridge in the rotational direction occurs and the filter cartridge sways, so that any stable filtration cannot be carried out, because the filter cartridge is not securely fixed to the inside of the filter housing, particularly in the rotational direction about the housing axis.

Further, in Patent Documents 2 and 3, the “collar” is made of a flexible material, so that when removing the filter cartridge together with the bowl, the filter cartridge and the bowl may be detached from each another by force in the rotational direction which can act on the filter cartridge. In this case, when the bowl is detached, the filter cartridge is still connected to and remains on the head side. Therefore, this device requires the ensuring of the space as described above as well as the movement of the displacement in the rotational direction of the filter cartridge cannot be sufficiently restricted.

An object of the present invention is to solve the above problems, and to provide a filtration device that can reduce a space required for replacing a filter cartridge and stably fix the filter cartridge in a filter housing.

### Solution to Problem

A filtration device of the present invention comprises a filter housing having a head, and a cylindrical bowl with a bottom, removably connected to the head; and a filter cartridge housed in the filter housing and having a filter portion, the filtration device being configured to allow liquid flowing in from an inflow port of the head to pass through the filter portion of the filter cartridge and allow the liquid to flow out of an outflow port of the head to filter the liquid, wherein the filter housing comprises at least one axial direction stopper for restricting displacement of the filter cartridge in a housing axial direction and at least one rotational direction stopper for restricting displacement of the filter cartridge in a rotational direction around a housing axis, and wherein the filter cartridge is removably secured to the bowl within the filter housing by the at least one axial direction stopper and the at least one rotational direction stopper.

In the filtration device according to the present invention, the filter cartridge may further preferably include at least one outward flange portion protruding toward the side of the bowl, and the bowl may preferably comprise at least one flange engaging portion that interposes the at least one outward flange portion from both sides in the housing axial direction, as the at least one axial direction stopper.

Further, in the filtration device according to the present invention, the filter housing may further include a stopper member that is engaged with each of the filter cartridge and the bowl, and the rotational direction stopper may be composed of at least one convex portion that is provided on one of the stopper member and the bowl and at least one concave portion that is provided on the other of the stopper member and the bowl and that interposes the at least one convex portion from both sides in the rotational direction.

In this case, it is preferable that each of the bowl and the stopper member may be provided with at least one pair of vertical wall surfaces interposing the outward flange portion from both sides in the rotational direction. Alternatively, it is preferable that the stopper member and the filter cartridge are engageable with each other by inserting at least one pin provided on one of the stopper member and the filter cartridge into at least one pin hole provided on the other.

Further, it is preferable that the at least one pin hole is provided on the at least one outward flange portion of the filter cartridge, the at least one concave portion is provided on the bowl, the stopper member disposed on the filter cartridge on the head side in the filter housing is annular, and the at least one convex portion is provided on the annular stopper member so as to protrude radially outward and the at least one pin is provided on the at least one convex portion of the stopper member so as to extend toward the side of the outward flange portion.

It is preferable that the at least one pin is inserted into and engaged with the at least one pin hole by press fitting. Specifically, it is preferable that the at least one pin has a head portion with increased diameter as compared to the other portion at a tip portion of the pin. It is preferable that the at least one convex portion is inserted into and frictionally engaged with the at least one concave portion by press fitting.

It is preferable that the stopper member is engagable with each of the filter cartridge and the bowl at two or more positions. Further, it is preferable that the portions of the stopper member to be engaged with each of the filter cartridge and the bowl are formed integrally with the stopper member.

It is preferable that the filtration device according to the present invention further comprises a connecting ring on an abutting position between the head of the filter housing and the bowl, wherein the connecting ring surrounds the abutting position from its outer side to connect the head and the bowl to each other, and wherein the bowl is detachable from the head together with the filter cartridge by removing the connecting ring.

### Advantageous Effects of Invention

According to the filtration device of the present invention, the filter housing is provided with the at least one axial direction stopper and the at least one rotational direction stopper, whereby the filter cartridge can be stably secured into the filter housing without wobbling in those directions. Further, according to the filtration device of the present invention, the filter cartridge is detachably secured to the bowl by the at least one axial direction stopper and the at least one rotational direction stopper, so that the bowl can be detached from the head together with the filter cartridge secured to the inside of the bowl, thereby reducing the space required for replacing work of the filter cartridge.

### BRIEF DESCRIPTION OF DRAWINGS

FIG. 1 is a perspective view showing a filtration device according to one embodiment of the present invention.

FIG. 2 is a longitudinal sectional view of the filtration device of FIG. 1.

FIG. 3 is an exploded perspective view showing each component of the filtration device of FIG. 1, excluding the head.

FIG. 4 is a perspective view showing a cartridge-housed bowl that assembled the respective components of FIG. 3.

FIG. 5 is a partially enlarged perspective view of the bowl of FIG. 3(a).

FIG. 6 is a plan view of the cartridge-housed bowl of FIG. 4 and a longitudinal sectional view taken along the line b-b of FIG. 4.

FIG. 7 is a perspective view showing respective steps of assembling the cartridge-housed bowl of FIG. 4.

FIG. 8 is a perspective view showing a bowl of a filtration device according to another embodiment.

FIG. 9 is a perspective view showing a cartridge-housed bowl including the bowl of FIG. 8.

### DESCRIPTION OF THE PREFERRED EMBODIMENTS

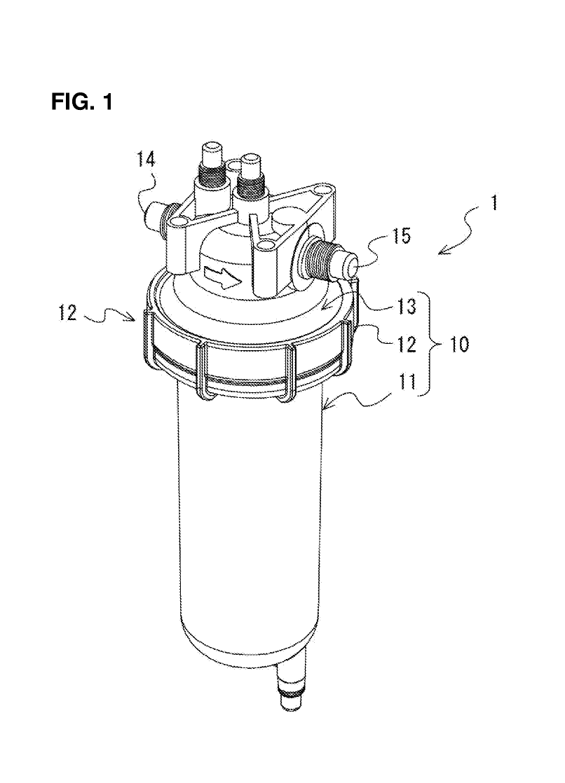

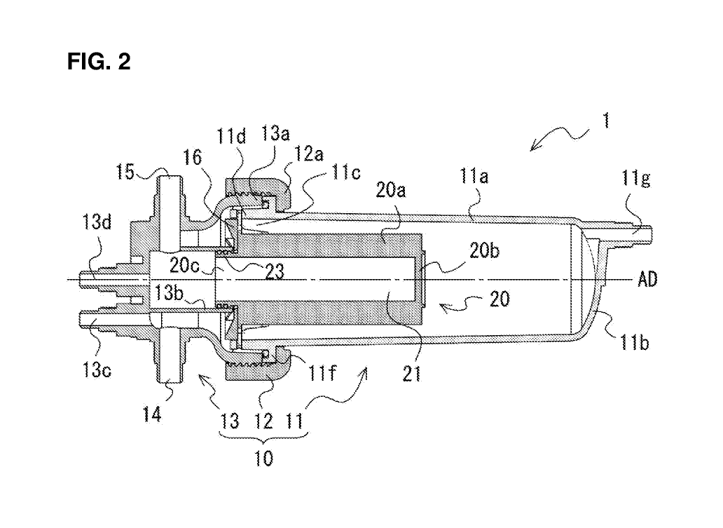

Embodiments of the present invention will be described in detail below with reference to the accompanying drawings. A filtration device 1 illustrated in FIGS. 1 and 2 comprises a filter housing 10 in the form of a container with a lid and a cylindrical filter cartridge 20 housed and arranged in the filter housing 10.

In the illustrated embodiment, as shown in FIG. 2 by a longitudinal sectional view including a housing axis AD, the filter housing 10 is configured to include a bowl 11 formed by sealing one end side (the right side in FIG. 2) of a cylindrical or other tubular portion 11a in the housing axial direction with a bottom portion 11b; and a head 13 detachably and liquid-tightly connected to an opening 11c arranged on other end side (the left side in FIG. 2) in the housing axial direction by a connecting ring 12 or the like. The head 13 may have, for example, a cylindrical inflow port 14 and a cylindrical outflow port 15 which extend to opposite sides of each other apart from the housing axis AD, and the inflow port 14 and outflow port 15 allow liquid to flow into the filter housing 10 and flow out of the filter housing 10. It should be noted that the term “housing axial direction” as used herein means a direction in which the housing axis AD extends through the center position of the transverse cross section of the cylindrical bowl 11.

Further, in the illustrated embodiment, the filter cartridge 20 may include a substantially cylindrical body portion 20a; and a bottom portion 20b provided on one end side of the body portion 20a, which side is the same as that of the bottom portion 11b of bowl 11 in the housing axial direction, and the filter cartridge 20 may also comprise an opening 20c on the other end side of the body portion 20a in the housing axial direction. In this case, the greater part of the filter cartridge 20 is positioned on the side of the bowl 11 inside the filter housing 10. The filter cartridge 20 is provided with a filter portion arrangement space 21 in the body portion 20a, and within the filter portion arrangement space 21a is a filter portion (not shown) for allowing the liquid flowing into the filter housing 10 to pass through. In addition, the cylindrical portion forming the body portion 20a is provided with a large number of openings through which liquid can pass.

Such a filtration device 1 may be used for filtering liquid such as ultrapure water and chemical liquid employed during production of semiconductors, microelectronics or the like, for example. In order to filter such liquid using the filtration device 1, certain liquid flowing into the head 13 from the inflow port 14 of the head 13 may flow toward the bowl 11 side, for example. The liquid may then pass through the body portion 20a from an outer circumference side to an inner circumference side of the filter cartridge 20, and contaminants in the liquid may be removed at the filter portion of the filter portion arrangement space 21 inside the body portion 20a. The liquid may then flow from the inside of the filter cartridge 20 to the inside of the head 13 and flow out of the filter housing 10 through the outflow port 15. However, this filtration method using the filtration device 1 is illustrative only, and the present invention is not limited to such a filtration method.

If the filtering device 1 is repeatedly used by the method as stated above, filtration performance of the filtration device 1 may be deteriorated because substances to be removed such as contaminants that may be contained in the above liquid adhere to the filter cartridge 20, in particular the filter portion. Therefore, it will be necessary to replace the filter cartridge 20 after using the filtration device 1 for a certain period of time or a certain number of times in order to always obtain a filtrate satisfying a predetermined high level of requirement.

Here, for the replacement of the filter cartridge, if the filter cartridge is structured to be attached to the head side in the filter housing, the bowl of the filter housing is detached by firstly disconnecting the bowl from the head, and then moving the bowl in a direction away from the head along the housing axial direction at a distance greater than or equal to the length in the housing axial direction of the filter cartridge until the filter cartridge extending to the inner side of the bowl is fully exposed. This structure causes a problem of depending on constraints on the arrangement space for the filtration device, which problem is that the bowl cannot be detached before replacing the filter cartridge if there is no sufficient space on the bottom side of the bowl of the filter housing to move the bowl for the longer distance as described above.

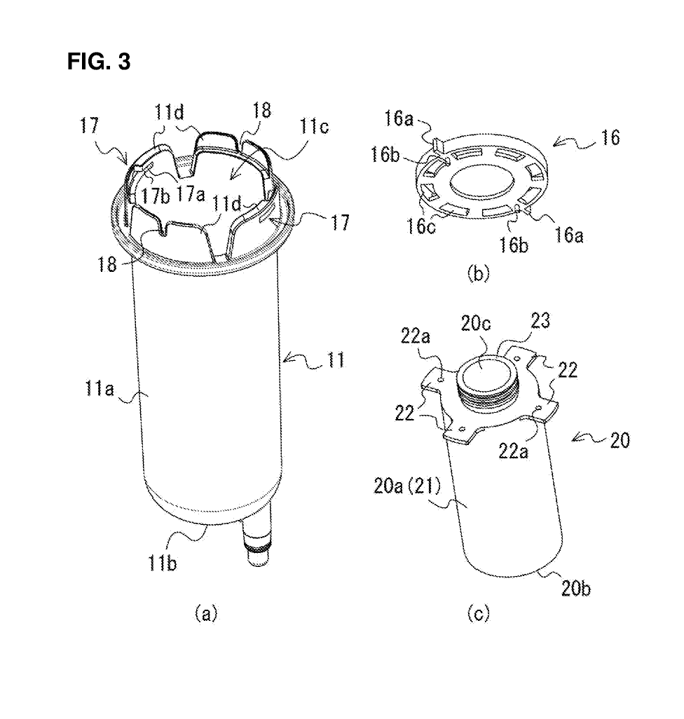

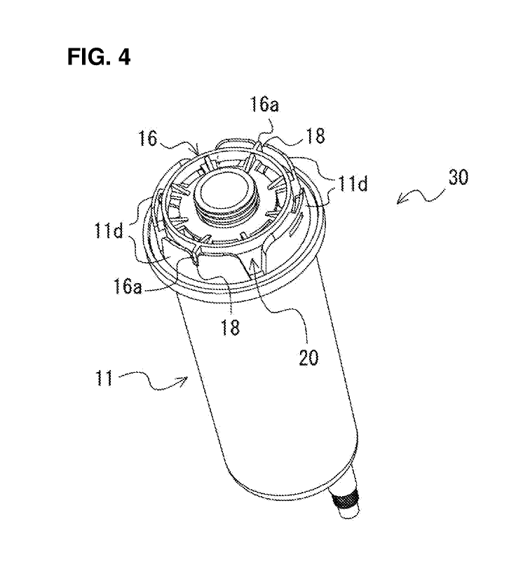

In order to address this problem, the present invention provides the filter cartridge 20 detachably secured to the bowl 11 inside the filter housing 10, as shown in FIG. 2. More specifically, in this embodiment, the filter housing 10 may further include a stopper member 16 that engages with each of the filter cartridge 20 and the bowl 11, as shown in FIG. 3 as the exploded perspective view of each component, and the filter cartridge 20 may be secured to the bowl 11 by the stopper member 16 as shown in FIG. 4 in a state where these components have been assembled. Thus, the filter cartridge 20 can be detached together with the bowl 11 from the head 13, so that even if the arrangement space of the filtration device 1 is not sufficient, the filter cartridge 20 can be easily replaced.

Further, according to the present invention, the filter housing 10 may be provided with at least one axial direction stopper for restricting displacement of the filter cartridge 20 in the housing axial direction and at least one rotational direction stopper for restricting displacement of the filter cartridge 20 in the rotational direction around the housing axis AD, in order to stably maintain the filter cartridge 20 in the filter housing 10. Therefore, when the filter cartridge 20 is housed in the filter housing 10, the displacement in both the housing axial direction and the rotational direction around the housing axis AD can be restricted to prevent unintentional shaking, so that as a further effect, the filtration of liquid can be stably carried out.

More particularly, in this embodiment, the filter cartridge 20 may include at least one plate-shaped outward flange 22 (four plate-shaped outward flanges 22 in the figure) on an outside edge surrounding the opening 20c, the outward flange 22 extending from the side edge toward the outer peripheral side, and the axial direction stopper as described above can be composed of at least one flange engaging portion 17 provided on an outside edge of the opening 11c on the other end side of the bowl 11. In this case, the outward flange portion 22 can be integrally formed with the filter cartridge 20 as shown in the illustrated embodiment.

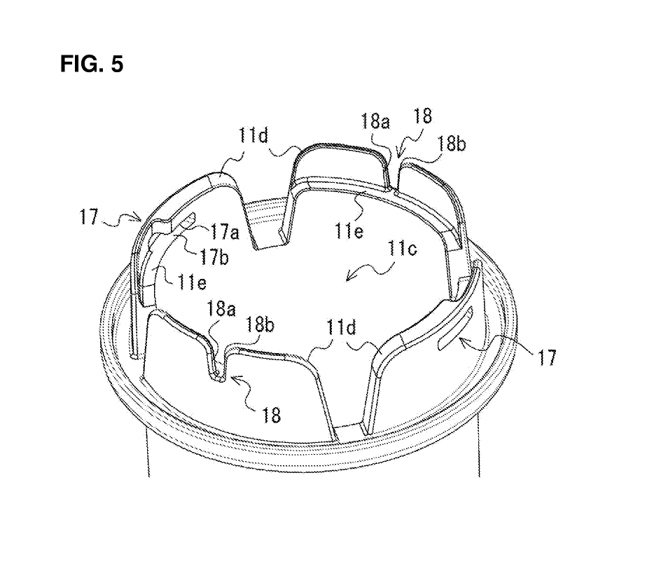

For example, as shown in the partially enlarged view of FIG. 5, the flange engaging portions 17 may be provided as piercing slits or non-piercing depressions interposing the outward flanges 22 from both sides in the housing axial direction, on the opening 11c of the bowl 11 so as to be parallel to the housing axial direction and at two of four vertical walls 11d standing along a part of the bowl 11 in the circumferential direction. The flange engaging portions 17 can function as axial direction stoppers by interposing the outward flange portions 22 from both sides in the housing axial direction as long as the flange engaging portions 17 are at least positioned on each of the side of the head 13 and the side of the bottom portion 11b in the housing axial direction and each flange engaging portion has abutting surfaces 17a and 17b which are in contact with both surfaces of the outward flange portion 22, respectively. However, for the housing axial direction, displacement can be restricted even if the outward flange portions 22 do not completely get caught in the flange engagement portions 17. Therefore, there may be a slight space between the outward flange portion 22 engaged with the flange engaging portion 17 and the abutting surfaces 17a, 17b.

In the illustrated embodiment, the vertical walls 11d are integrally formed with the bowl 11, and the outward flange portions 22 are directly connected to the flange engaging portions 17 provided on the vertical walls 11d without directly interposing other member(s).

In this embodiment, the outer surface of the stopper member 16 presenting a ring shape such as an annular shape is provided with at least one convex portion 16a protruding outward in the radial direction of the stopper member 16, as shown in FIG. 3, and the vertical walls 11d of the bowl 11 are provided with at least one concave portion 18 which may be in the form of a slit, interposing the inwardly inserted convex portion 16a from both sides in the rotational direction (the circumferential direction around the housing axis), as shown in FIG. 4 as the assembly. Any rotation displacement of the stopper member 16 relative to the filter housing 10 is restricted by the engagement of the convex portions 16a with the concave portions 18, so that any displacement in the rotational direction of the filter cartridge 20 engaged with the stopper member 16 will also be restricted as will be described below.

In the illustrated embodiment, each concave portion 18 provided by notching a part of the top surface side of the vertical wall 11d is more preferably slightly narrower than the width of the convex portion 16a, whereby the convex portion 16a can be inserted by press fitting to be frictionally engaged with the convex portion 16a. In such a way, the stopper member 16 can be strongly engaged with the bowl 11 so that any displacement in the rotational direction of the stopper member 16 and the filter cartridge 20 relative to the filter housing 10 can be more reliably prevented. Alternatively, although not shown in the drawings, the concave portions may be formed as depressions provided on the inner surfaces of the vertical walls without piercing the vertical walls, and the two convex portions positioned on a straight line orthogonal to the central axis of the stopper member may be press-fitted between the inner surfaces of the corresponding two concave portions, whereby the two convex portions can be frictionally engaged with the two concave portions by stretching the convex portions between the two concave portions in the radial direction of the bowl. In this case, the internal filter cartridge is held by the stopper member having the two convex portions frictionally engaged between the two concave portions, so that pins and pin holes described below will not be required. When frictionally engaged in such a way, three or more concave and convex portions may be provided.

However, each concave portion 18 may be at least brought into contact with each convex portion 16a from both sides of the concave portion 18 in the rotational direction so as to have the respective abutting surfaces 18a and 18b which interpose the convex portion 16a from both sides in the rotational direction, as shown in FIG. 5. In this case, the concave portions 18 are provided on the two vertical walls 11d that do not have the flange engaging portion 17, among the four vertical walls 11d.

Further, as shown in FIG. 3, the stopper member 16 may be provided with one or more substantially columnar pins 16b extending toward the side of the filter cartridge 20, while the filter cartridge 20, for example, the outward flange portions 22, may be provided with substantially round hole-shaped pin holes 22a with which the pins 16b are engaged, the positions and the numbers of the pin holes corresponding to those of the pins 16b. Here, the two pins 16b are provided on the stopper member 16, and the total four pin holes 22a are provided on the respective four outward flange portions 22 of the filter cartridge 20. In this case, even if the filter cartridge 20 is in the position where the filter cartridge 20 is rotated by 90° around the housing axis relative to the stopper member 16, the pins and the holes can be engaged with each other.

The pins 16b and the pin holes 22a may be only required to engage with each other when the stopper member 16 is disposed on the filter cartridge 20, and their arrangement positions are not particularly limited. Therefore, it is also possible to provide the pins at the convex portions of the stopper member if the positions of the pin holes of the outward flange portion 22 are shifted to the outer peripheral side, although not shown in the figure.

When the pins 16b and the pin holes 22a are provided and these are used for engagement between the stopper member 16 and the filter cartridge 20, it is preferable to have a structure in which the pins 16b are press-fitted and inserted into the pin holes 22a, in order to firmly engage the stopper member 16 with the filter cartridge 20. This can be achieved, such as by forming the pins 16b each having a spherical head with larger diameter than that of the other portions at the tip portion of each pin 16b, and slightly increasing the maximum diameter of the head as compared with the inner diameter of each pin hole 22a.

Such a structure of the stopper member 16 serves not only as a stopper in the rotational direction of the filter cartridge 20 but also to provide engagement between the stopper member 16 and the bowl 11. The convex portions 16a as the engaging portions may be preferably formed integrally with the stopper member 16 as shown in the illustrated embodiment, in terms of reduction of the number of members and ease of assembly and the like. Although not shown in the drawing, the convex portions may be provided on the bowl side and the concave portions may be provided on the stopper member side.

It is preferable to provide two or more engaging portions of the stopper member 16 with the filter cartridge 20 and the bowl 11, such as the pins 16b and the pin holes 22a or the convex portions 16a and the concave portions 18 as described above. Thus, the engagement of the stopper member 16 with each of the filter cartridge 20 and the bowl 11 can be strengthened. In the illustrated embodiment, the two pins 16b and the two pin holes 22a are engaged with each other, as well as the two convex portions 16a and the two concave portions 18 are engaged with each other.

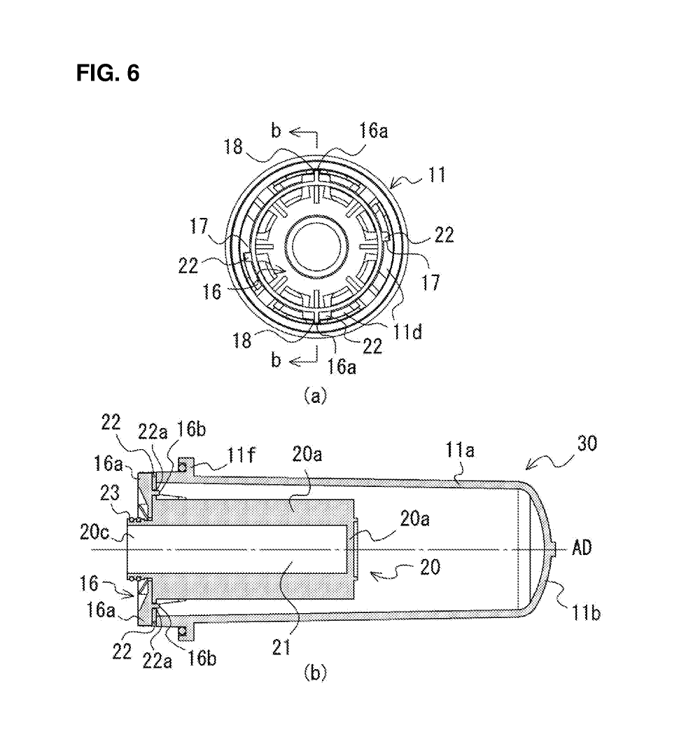

By assembling the bowl 11, the stopper member 16 and the filter cartridge 20 as described above, the cartridge-housed bowl 30 as shown in FIGS. 4 and 6 can be formed. As can be seen from FIGS. 4 and 6(a), in the cartridge-housed bowl 30, each convex portion 16a provided on the stopper member 16 is put in each concave portion 18 provided on the vertical wall 11d of the bowl 11, and as can be seen from FIG. 6(b), each pin 16b provided on the stopper member 16 is inserted into each pin hole 22a provided on the outward flange portion 22 of the filter cartridge 20. This can allow engagement of the stopper member 16 with the bowl 11 and prevention of any displacement of the filter cartridge 20 in the rotational direction about the housing axis relative to the filter housing 10.

Further, each outward flange portion 22 of the filter cartridge 20 herein gets caught in the flange engaging portions 17 of the bowl 11. This can prevent any displacement of the filter housing 10 in the axial direction of the housing. Consequently, the filter cartridge 20 can be secured to the side of the bowl 11 and stably held in the filter housing 10.

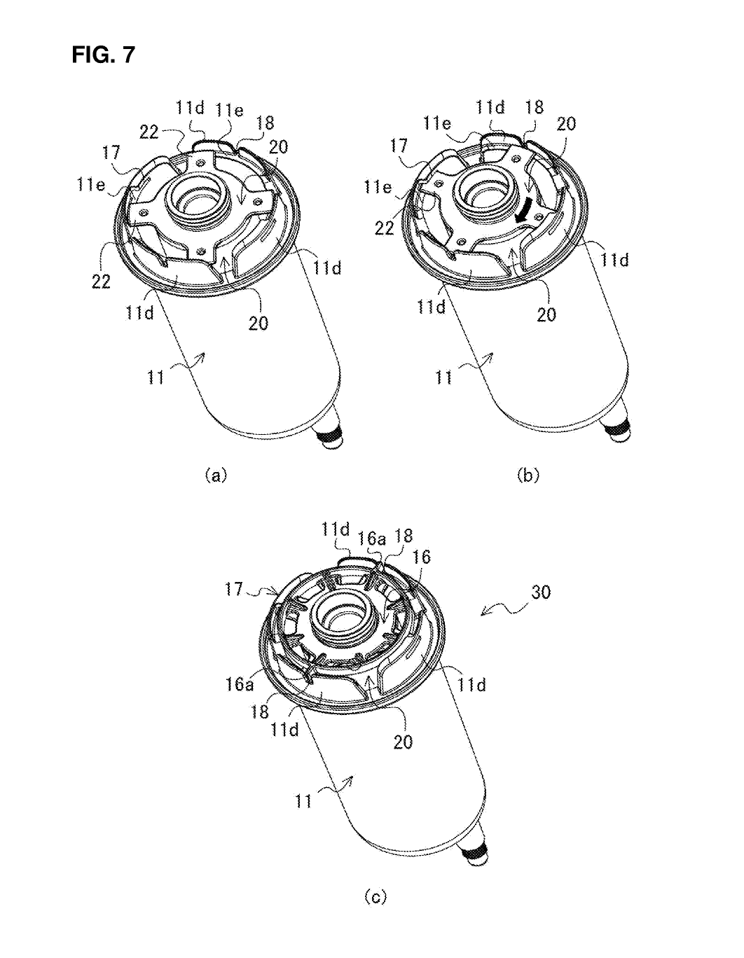

To assemble the cartridge-hosed bowl 30 as shown in FIGS. 4 and 6, the filter cartridge 20 is inserted and arranged into the inside of the bowl 11 in an direction where their axes coincide with the housing axis AD, as shown in FIG. 7 (a). Here, the outward flange portions 22 of the filter cartridge 20 are temporarily placed on support surfaces 11e facing outward in the housing axial direction on the inner surface side of the vertical walls 11d of the bowl 11. In each vertical wall 11d that formed the flange engaging portion 17, the support surface 11e is continuous to one abutting surface 17b of the flange engaging portion 17 along the circumferential direction of the housing.

As shown by the arrow in FIG. 7(b), the filter cartridge 20 is then rotatingly displaced around the housing axis AD, whereby each outward flange portion 22 positioned on each support surface 11e of each vertical wall 11d provided with the flange engaging portion 17 is slidingly inserted into a gap between the abutting surfaces 17a and 17b of each flange engaging portion 17. By this operation, each outward flange portion 22 of the filter cartridge 20 gets caught in the flange engaging portion 17 of the bowl 11 from both sides in the axial direction of the housing.

As shown in FIG. 7 (c), the stopper member 16 is then disposed on the filter cartridge 20 in the bowl 11, and the stopper member 16 is installed by engaging the stopper member 16 with each of the filter cartridge 20 and the bowl 11. At this time, as shown in FIG. 7(c), the plate-shaped convex portions 16a protruding toward the outside of the stopper member 16 are inserted into the slit-shaped concave portions 18 provided on the vertical walls 11d of the bowl 11, and the pins 16b provided on the stopper member 16 are inserted into the pin holes 22a of the outward flange portions 22 of the filter cartridge 20, as described above, although not shown in FIG. 7(c). In such a way, the filter cartridge 20 can be fixed to the bowl 11 and housed therein to assemble the cartridge-housed bowl 30 while restricting any displacement of the filter cartridge 20 in both the housing axial direction and the rotational direction around the housing axis.

In addition, when attaching the above cartridge-housed bowl 30 to the head 13, the outer peripheral sides of the vertical walls 11d of the bowl 11 are surrounded by an O ring 13a of the head 13, and the cartridge-housed bowl 30 is inserted into the inside of the head 13 such that the opening 13c of the bowl 11 is covered with the head 13, as shown in FIG. 2. At this time, the peripheral edge of the O ring 13a of the head 13 abuts against an annular flange 11f provided on the outer peripheral surface of the bowl 11 over the entire circumference of the O ring 13a, and a cylindrical O ring 23 having a smaller diameter, which is exposed from the bowl 11, around the opening 20c of the filter cartridge 20, is inserted into a cylindrical connecting tubular portion 13b having a larger diameter, which is formed on the inner side of the head 13. In addition, the O ring 23 of the filter cartridge 20 is inserted into the connecting tubular portion 13b having slightly smaller inner diameter than the outer diameter of the O ring 23, whereby final centering of the filter cartridge 20 in the filter housing 10 occurs so that wobble of the filter cartridge 20 can be further suppressed.

In this state, the connecting ring 12 provided with thread grooves or thread ridges on the inner circumferential surface is brought onto the outer circumferential side of the bowl 11 from the bottom portion 11b side, and the connecting ring 12 is disposed so as to surround the annular flange 11f of the bowl 11 while contacting the inner flange portion 12a on one end side of the connecting ring 12 with the annular flange 11f, and the thread grooves or thread ridges on the connecting ring 12 are screwed to corresponding thread ridges or thread grooves provided on the outer circumferential side of the O ring 13a of the head 13. In such a way, the annular flange 11f of the bowl 11 can be sandwiched between the inner flange portion 12a of the connection ring 12 and the O ring 13a of the head 13 screwed into the connection ring 12 to connect the head 13 and the cartridge-housed bowl 30 to each other. The use of such a connecting ring 12 provides an advantage that the bowl 11 can be easily detached from the head 13 together with the filter cartridge 20.

Further, the O ring 13a of the head 13 and the O ring 23 of the bowl 11 can ensure a liquid-tight property at a position where leakage of liquid should be prevented. The stopper member 16 may be provided with one through hole 16c or a plurality of through holes 16c at predetermined intervals along the circumferential direction of the annular stopper member 16, which through hole(s) 16c allow(s) the liquid flowing into the head 13 to flow through the interior of the bowl 11 side. Further, here, each of the through holes of the stopper member 16 is provided with a reinforcing rib that extends toward the annular part on the outer peripheral side of the though hole and has a triangular shape as viewed from the side, in order to prevent the reduction of strength of the stopper member 16 due to the arrangement of the through holes 16c.

The bottom portion 11b of the bowl 11 may be provided with a drain 11g for discharging liquid out of the filtration device 1 during discharging effluent from the device, and the inflow port 14 side and the outflow port 15 side may be provided with vent holes 13c and 13d, respectively, for allowing the flowing of a gas inside and outside the filtration device 1 during discharging the liquid from the drain 11g. During normal use of the filtration device 1, these drains 11g and vent holes 13c, 13d are hermetically sealed by attaching a cap (not shown).

The head 13, the bowl 11, the stopper member 16 and the body portion 20a of the filter cartridge 20 among the respective elements for the filtration device 1 may be made of any materials as long as they are resistant to the liquid to be filtered, including plastics (preferably polyethylene including ultrahigh molecular weight polyethylene, polypropylene, PTFE, PFA, PVDF and other fluorine resins, polycarbonates, polysulfones, and polyethersulfones). Materials of the head 13 and the bowl 11 may be selected from desired materials depending on their applications, including, in addition to the above-listed materials, glass, or metals such as stainless steel, aluminum, copper, nickel, chromium, titanium, or alloys or mixtures thereof. Further, the filter portion of the filter cartridge 20 may be made of any material ordinarily used for the filtration, such as paper, cellulosic materials, glass fibers and fabrics, metals such as stainless steel, nickel, chromium, and alloys and mixtures thereof, ceramics, plastics, and preferably thermoplastic materials including materials listed below, and the like. The thermoplastic materials include polyethylene such as ultrahigh molecular weight polyethylene, polypropylene, PVDF, PTFE, PFA and other fluorine resins, PCV, nylons, polyamides, polysulfones, polyimides, polycarbonates, PET and the like.

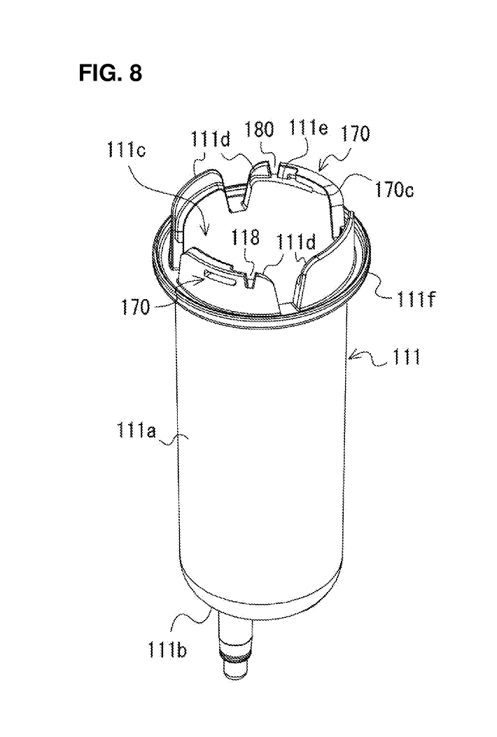

FIG. 8 shows a perspective view of the bowl of the filtration device according to another embodiment. The embodiment as shown in FIG. 8 is substantially the same as the embodiments described above, with the exception that the structure of the rotational direction stopper is mainly changed by having different shapes of the vertical walls 111d of the bowl 111 from those of the embodiments as described above.

That is, in this embodiment, concave portions 180 are provided on vertical walls 111d provided with flange engaging portions 170 among the vertical walls 111d of a bowl 111, as shown in FIG. 8. Each concave portion 180 is located on a support surface 111e at a slight distance from the flange engagement portion 170 in the circumferential direction of the bowl 111.

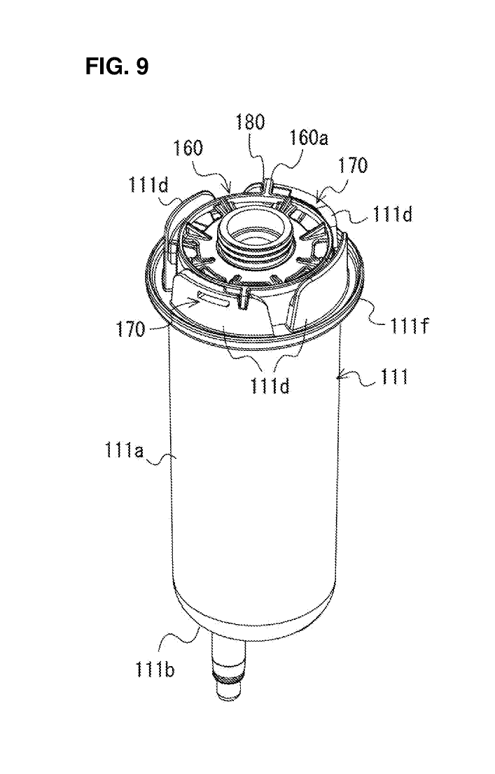

In such a bowl 111, a filter cartridge is arranged and a stopper member 160 is attached. As shown in FIG. 9, when each of convex portions 160a of the stopper member 160 is inserted into each of the concave portions 180 of the bowl 111, each of outward flange portions of the filter cartridge is interposed between each of vertical wall surfaces 170c at the deepest position of each flange engaging portion 170 and each vertical wall surface serving as the side surface of the convex portion 160a of the stopper member 160, whereby any displacement of the filter cartridge in the rotational direction will be restricted. That is, the convex portions 160a of the stopper member 160 are engaged with the bowl 111 by being inserted into the concave portions 180, while at the same time the vertical wall surfaces of the convex portions 160a cooperate with the paired vertical walls 170c of the flange engaging portions 170 when the convex portions 160a come into the concave portions 180, thereby functioning to secure the outward flange portions of the filter cartridge so as not to be displaced in the rotational direction. In this embodiment, a gap may be present between the vertical wall surface and the outward flange as long as the outward flange portions of the filter cartridge do not get out in the rotational direction of the filter cartridge.

In the embodiment as shown in FIGS. 8 and 9, the vertical wall surfaces of the convex portions 160a and the vertical wall surfaces 170c of the flange engaging portions 170 function as a rotational direction stopper for restricting any displacement of the filter cartridge in the rotational direction about the housing axis, so that it is not indispensable to provide the stopper member 160 and the filter cartridge with the pins 16b and the pin holes 22a shown in FIG. 3 as described above.

### DESCRIPTION OF REFERENCE NUMERALS

1 filtration device
10 filter housing
11, 111 bowl
11a, 111a cylindrical portion
11b, 111b bottom portion
11c, 111c opening
11d, 111d vertical wall
11e, 111e support surface
11f, 111f annular flange
11g drain
12 connecting ring
12a inner flange portion
13 head
13a O ring
13b connecting tubular portion
13c vent hole
14 inflow port
15 outflow port
16, 160 stopper member
16a, 160a convex portion (rotational direction stopper)
16b pin
16c through hole
17, 170 flange engaging portion (axial direction stopper)
17a, 17b abutting surface
170c vertical wall surface (rotational direction stopper)
18, 180 concave portion (rotational direction stopper)
18a, 18b abutting surface
20 filter cartridge
20a body portion
20b bottom portion
20c opening
21 filter portion arrangement space
22 outward flange portion
23 O ring
30 cartridge-housed bowl
AD housing axis

1-12. (canceled)

13. A filtration device, comprising:
a filter housing having a head with an inflow port, an outflow port, and a cylindrical bowl with a bottom, the bowl being removably connected to the head; and
a filter cartridge housed in the filter housing and having a filter portion, the housing being configured to allow liquid flowing from the inflow port to pass through the filter portion of the filter cartridge and out of the outflow port;
wherein the bowl of the filter housing comprises at least one axial direction stopper configured for restricting displacement of the filter cartridge in a housing axial direction and at least one rotational direction stopper for restricting displacement of the filter cartridge in a rotational direction around a housing axis, and wherein the filter cartridge is removably secured to the bowl within the filter housing by the at least one axial direction stopper and the at least one rotational direction stopper.

14. The filtration device according to claim 13, wherein the filter housing further includes a stopper member that is engaged with each of the filter cartridge and the bowl.

15. The filtration device according to claim 13, wherein the filter cartridge further includes at least one outward flange portion protruding toward the side of the bowl, and wherein the bowl comprises at least one flange engaging portion that interposes the at least one outward flange portion from both sides in the housing axial direction, as the at least one axial direction stopper.

16. The filtration device according to claim 13, wherein the filter housing further includes a stopper member that is engaged with each of the filter cartridge and the bowl, and wherein the rotational direction stopper comprises at least one convex portion that is provided on one of the stopper member and the bowl, and at least one concave portion that is provided on the other of the stopper member and the bowl and that interposes the at least one convex portion from both sides in the rotational direction.

17. The filtration device according to claim 16, wherein the filter cartridge further includes at least one outward flange portion protruding toward the side of the bowl, and wherein each of the bowl and the stopper member is provided with at least one pair of vertical wall surfaces interposing the outward flange portion from both sides in the rotational direction.

18. The filtration device according to claim 16, wherein the stopper member and the filter cartridge are engagable with each other by at least one pin on one of the stopper member and the filter cartridge that is insertable into at least one pin hole provided on the other of the stopper member and the filter cartridge.

19. The filtration device according to claim 18,
wherein the filter cartridge further includes at least one outward flange portion protruding toward the side of the bowl, and wherein the at least one pin hole is provided on the at least one outward flange portion of the filter cartridge, and the at least one concave portion is provided on the bowl; and
wherein the stopper member disposed on the filter cartridge on the head side in the filter housing is annular, and the at least one convex portion is provided on the annular stopper member so as to protrude radially outward, and the at least one pin is provided on the at least one convex portion of the stopper member so as to extend toward the side of the outward flange portion.

20. The filtration device according to claim 18, wherein the at least one pin is insertable into and engageable with the at least one pin hole by press fitting.

21. The filtration device according to claim 20, wherein the at least one pin has a head portion with increased diameter as compared to the other portion at a tip portion of the pin.

22. The filtration device according to claim 16, wherein the at least one convex portion is insertable into and frictionally engageable with the at least one concave portion by press fitting.

23. The filtration device according to claim 16, wherein the stopper member is engageable with each of the filter cartridge and the bowl at two or more positions.

24. The filtration device according to claim 16, wherein the portions of the stopper member to be engaged with each of the filter cartridge and the bowl are formed integrally with the stopper member.

25. The filtration device according to claim 13, further comprising a connecting ring on an abutting position between the head of the filter housing and the bowl, wherein the connecting ring surrounds the abutting position from its outer side to connect the head and the bowl to each other; and wherein the bowl is detachable from the head together with the filter cartridge by removal of the connecting ring.
